(19) United States
(12) Patent Application Publication
(10) Pub. No.: US 2007/0123094 A1
(43) Pub. Date: May 31, 2007

(54) Electrical connector

(75) Inventors: Tien-Chien Su, Tu-Cheng (TW); Yi-Feng Wu, Tu-Cheng (TW); Hsiu-Yuan Hsu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/605,503

(22) Filed: Nov. 28, 2006

(30) Foreign Application Priority Data
Nov. 28, 2005 (TW) 94220591

(51) Int. Cl. H01R 12/24

(52) U.S. Cl. 439/492

(57) ABSTRACT

An electrical connector (1) comprises a housing (10) disposed a number of receiving slots (105) and a number of electrical contacts (20) received in the housing (10). Each slot (105) defines four inner walls. The contacts (20) defines a first sidewall (207) and a second sidewall (208) opposite to the first sidewall (207), a solder portion (201) defined on a distal end thereof, an elastic portion (205) disposed on a top end thereof, and a retention portion (202) connecting the solder portion (201) and the elastic portion (205), wherein at least one sidewall of the contact (20) is cleared off with inner walls of the receiving slots (105). The elastic portion (205) defines a contact portion (2054) on an end thereof for connecting with the flexible printed circuit. Each contact (20) defines at least one protrusion on a sidewall which is clear off the inner wall of the slot (105).

### BACKGROUND OF THE INVENTION

1. Field of the Invention

The present invention relates to an electrical connector for electrically connecting a flexible printed circuit to a printed circuit board (PCB).

2. Description of Related Art

A conventional electrical connector for connecting a flexible printed circuit to a printed circuit board comprises an insulative housing, an actuator pivotably mounted on the housing and a plurality of contacts received in the housing. A flexible printed circuit connecting with the electrical connector defines a plurality of pads on a bottom thereof for connecting with the contacts received in the housing. The actuator can be rotated between an opening position and a closed position. When the actuator is operated in the opening position, the flexible printed circuit is inserted into a receiving cavity of the housing; when the actuator is operated in the closed position, the actuator abuts against the flexible printed circuit tightly for attaining a reliable contact between the pads of the flexible printer circuit and the contacts in the housing. The housing defines a respective receiving slot for receiving a corresponding contact therein. The width of each receiving slot generally defines a minimum value. When the width is defined smaller than the minimum size. The slots of the housing would be hard to mold. The thickness of each contact receiving in the slot of the housing is slightly smaller than the width of the corresponding slot. When the contacts are inserted into the slots of the housing, two sidewalls of each contact abut against the inner wall of each slot of the housing, which can prevent the contacts received in the slots of the housing from shaking too much, when the contacts are pressed downwardly by the actuator, thereby ensuring a reliable electrical connection between the flexible printed circuit and the printed circuit board.

However when high frequency signals are transmitted between the flexible printed circuit board and the printed circuit board, the thickness of the contact is generally decreased for decreasing capacitive effect between adjacent contacts. While the width of the slot in the housing attains a minimized size permitted by the molding demand, the thickness of the contact decreased can lead to a wider distance between the outer sidewalls of the contact with the inner wall of the slot in the housing, so that the contacts receiving in the slots shake greater which can bring about the pads of the flexible printed circuit sliding out from the slots of the housing. Hence the flexible printed circuit can not reliably be electrically connected with the printed circuit board.

Thereby, an improved electrical connector is required to overcome the disadvantages of the prior art.

### SUMMARY OF THE INVENTION

An object of the present invention is to provide an electrical connector which has reliable structure and can perform securely electrical connection between a flexible printed circuit and a printed circuit board (PCB).

In order to achieve above-mentioned objects, an electrical connector in accordance with a preferred embodiment of the present invention includes a housing defining a plurality of receiving slots, a number of electrical contacts received in the housing. Each slot defines four inner walls. The contacts defines a first sidewall and a second sidewall opposite to the first sidewall, a solder portion defined on a distal end thereof, an elastic portion disposed on a top end of the contact and a retention portion connecting the solder and the elastic portion, wherein at least one sidewall of the contact is cleared off with inner walls of the receiving slots, the elastic portion defines a contact portion on an end thereof for connecting with flexible printed circuit, each contact defines at least one protrusion on a sidewall which is clear off the inner wall of the slot.

Compared to the conventional technology, the electrical connector in accordance with the invention can decrease thickness of the contacts. When the width of the receiving slots of the housing attains a minimized size, the distance between the first sidewall and the second sidewall is decreased. After the contacts are inserted into the housing, the distance between at least one of sidewalls of the contact and the inner walls of the receiving slot increases. However the projection disposed on the contact can compensate the distance between the contact and the receiving holes of the housing, thus diminishing the swing degree of the contact and preventing the contact portion of the contact from disconnecting with the pads of the flexible circuit board, which can ensure a reliable electrical connection between the electrical connector and the flexible circuit board.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an exploded, isometric view of an electrical connector in accordance with a preferred embodiment of the present invention;

FIG. 2 is an assembled view of the electrical connector described in FIG. 1;

FIG. 3 is an isometric view a contact of the electrical connector showing in FIG. 1;

FIG. 4 is an top plan view of the electrical connector showing in FIG. 1;

FIG. 5 is an amplified view of a circle 100 of the FIG. 4.

### DETAILED DESCRIPTION OF THE INVENTION

Reference will now be made to the drawing figures to describe the present invention in detail.

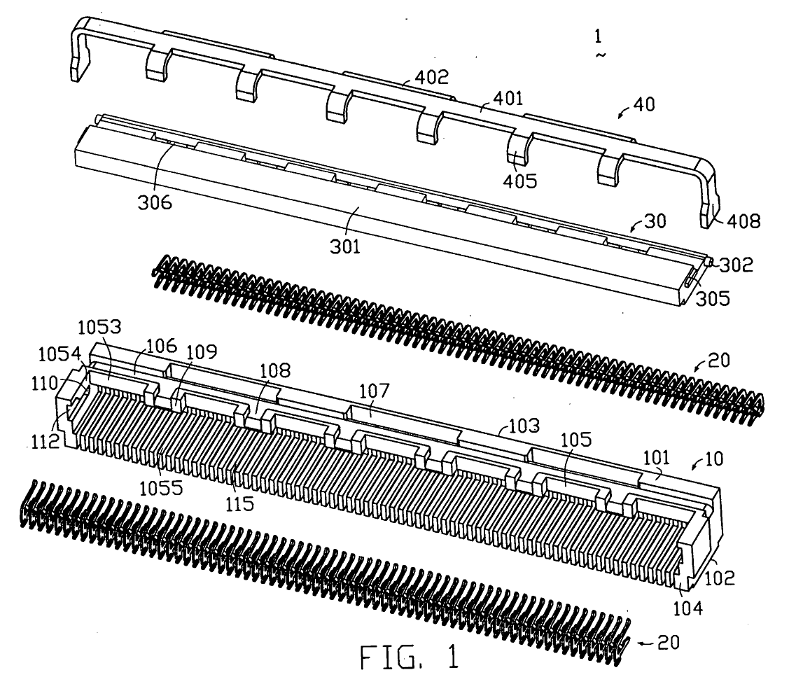

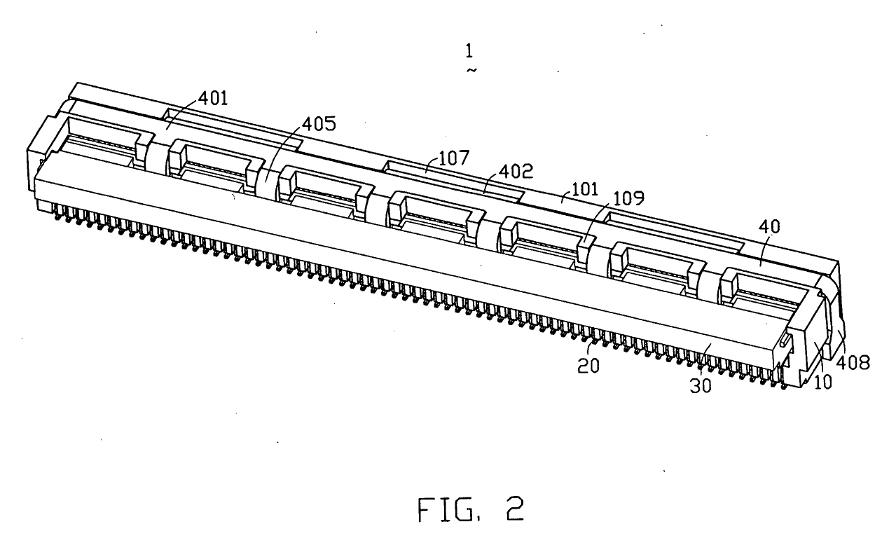

Referring to FIGS. 1-5, an electrical connector 1 in accordance with the preferred embodiment of the present invention comprises a housing 10, a plurality of electrical contacts 20 received in the housing 10, an actuator 30 mounted pivotally on the housing 10, and a cover 40 disposed above the housing 10.

The rectangular housing 10 comprises a first surface 101 and a second surface 102 parallel to the first surface 101, a first sidewall 103 and a second sidewall 104 perpendicular to the first surface 101. The first surface 101 defines downwardly a plurality of receiving slots 105 and a securing channel 106, which do not penetrate through the second surface 102. The housing 10 further defines a first receiving recess 107 adjacent to the first sidewall 103 in a transverse direction, and a second receiving recess 108 adjacent to the second sidewall 104. The receiving slots defines a bottom surface 1055, a first inner surface 1053 and a second inner surface 1054 perpendicular to the first inner surface 1053, an anchoring projection 109 extending from the first inner surface 1053 toward the second sidewall 104, and a first engaging slot 110 and a second engaging slot 112 disposed on the second inner surface 1054 and connecting with each other. In addition, the second surface 102 defines inwardly a pair of receiving passageways 115 for receiving the contacts 20 therein.

The actuator 30 defines a rectangular base plate 301. The base plate 301 disposes a retention post 302 and a securing projection 305 on two ends thereof, and a plurality of channels 306 well distributed for preventing actuator 30 from interference with the anchoring projection 109.

The cover 40 comprises a rectangular base portion 401, a first engaging hook 402 and a second engaging hook 405 disposed on two transverse ends thereof. The base portion 401 defines a pair of solder tails 408 on the longitudinal ends thereof for connecting to the printed circuit board, which can enhance the stability and reliability of the connection between the electrical connector 1 and the printed circuit board.

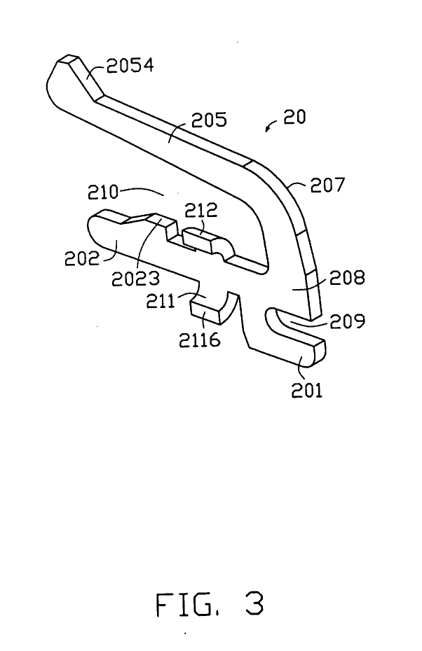

Referring to FIGS. 3-5, each contact 20 defines a solder portion 201, a retention portion 202, an elastic portion 205, a first channel 209 disposed in the solder portion 201 and a second channel 210 disposed between the retention portion 202 and the elastic portion 205. In addition, each contact 20 further defines a first sidewall 207 and a second sidewall 208. In this embodiment when the contacts 20 are inserted into the housing 10, each first sidewall 207 abuts against the inner wall of the receiving passageway 115; each second sidewall 208 is clear off a wider distance with the inner wall of the receiving passageway 115. The retention portion 202 extends a first projection 211 and a second projection 212 from the first sidewall 207 toward the second sidewall 208, which is disposed on upper and lower position of the retention portion 202 respectively and extending beyond the second sidewall 208. The first projection 211 and the second projection 212 each define an outer surface 2116 parallel to the second sidewall 208. The retention portion 202 defines an engaging portion 2023 for engaging with the corresponding portion of the receiving passageway 115. In fact, if each contact 20 in accordance with the invention only defines a projection, namely the first projection 211 or the second projection 212, the electrical connector 1 can also attains the object of the invention. In addition, when the contacts 20 are inserted into the receiving holes of the housing 10, if the first sidewall 207 and second sidewall 208 of the contact 20 are both clear off a distance with the inner wall of the receiving passageway 105, the retention portion 202 can disposed a third projection and a fourth projection on central section thereof, which are disposed on upper and lower position of the retention portion 202 respectively and one projection extending out of the first sidewall 207 and the other projection extending out of the second sidewall 208. In this state, the objection of the invention can also be attained.

In assembly, the contacts 20 are inserted into the receiving passageways 115 of the housing 10 and disposed opposite to each other, wherein the elastic portion 205 partially extends out of the receiving slot 105 of the housing 10, namely a free end of the elastic portion 205 locating above the bottom surface 1055 of the receiving slot 105, and the solder portion 201 extends beyond the receiving holes 115 in order to solder to the printed circuit board. And then the actuator 20 is inserted into the housing 10 in a direction parallel to the first surface 101 of the housing 10. In the state, a lower surface of the anchoring projection 109 abuts against a corresponding surface of the actuator 30, the retention posts 302 of the actuator 30 are engaged with receiving slots 105 of the housing 10 and the securing projection 305 are received in the second engaging slot 112. At this time, the actuator 30 mounted on the housing 10 can rotate about the retention posts 302 of the actuator 30. At last, the cover 40 is mounted on the housing 10, the base portion 401 engages with the securing channel 106 of the housing 10 and the first hook 402 is inserted into the first receiving recess 107, and the second hook 405 is inserted into the second receiving recess 108. Hence the cover 40 is located on the housing 10.

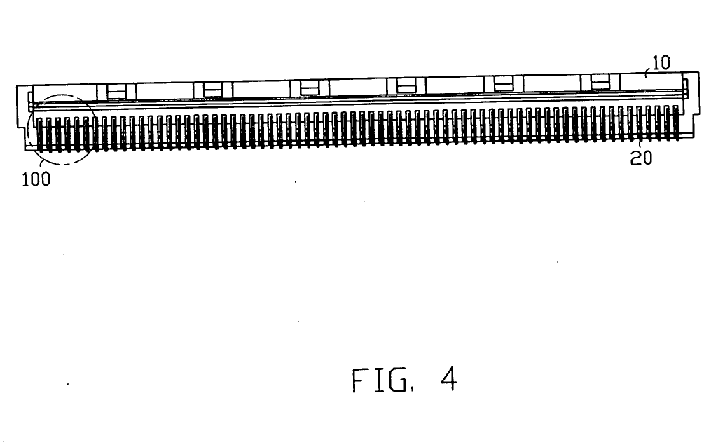

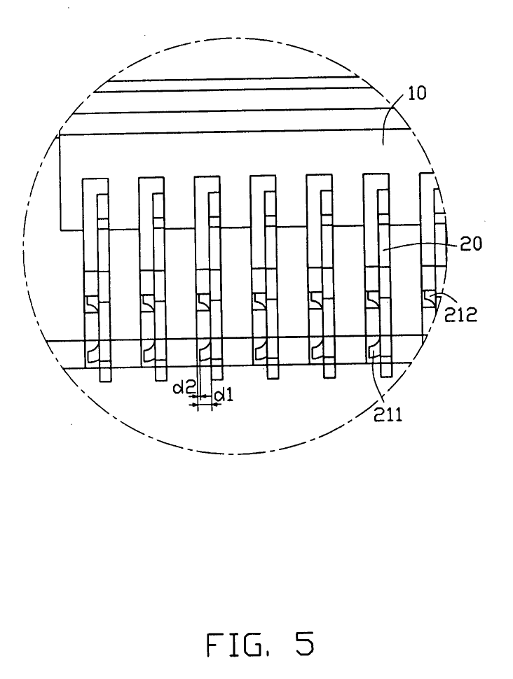

After the electrical connector is assembled, when the actuator is rotated from a horizontal position to an opening position, the flexible printed circuit can be inserted into a space under the bottom surface 1055 of the receiving slot 105; at this time, the flexible printed circuit contacts with the contacts 20. The actuator 30 then is rotated to the horizontal position and presses the flexible printed circuit downwardly, thereby preventing the flexible printed circuit from sliding off. In this process, when the flexible printed circuit presses contacts 20 downwardly, the elastic portion 105 generates an elastic deformation and the contact portion 2054 slides on the surface pad of the flexible printed circuit. Turning to FIGS. 4-5, after the contacts 20 are inserted into the housing 10, the first sidewall 107 abuts against the inner wall of the receiving passageways 115 and the second sidewall 108 is clear off the inner wall with a distance d1. Since the contact 20 defines a first projection 211 and a second projection 212, there is a slight distance d2 between the outer surface of the contact and the inner wall of the passageways 115, thereby decreasing shaking of the contacts 20 and preventing the contact portion 115 from sliding out of the flexible printed circuit, which ensures a reliable electrical connection between the electrical connector and the flexible printed circuit.

1. An electrical connector for electrically connecting a flexible printed circuit to a printed circuit board, comprising:
a housing defining a plurality of receiving passageways therethrough, each passageway being disposed with an inner wall;
a plurality of contacts received in the passageways of the housing and each contact comprising a first sidewall, a second sidewall, a solder portion, a retention portion, and an elastic portion disposed along the sidewall, wherein at least one sidewall is clear off the inner wall, the elastic portion defining a contact portion for connection with a flexible printed circuit;
wherein the contact further defines at least one projection extending from the sidewall and having a clearance with the inner wall of the passageway.

2. The electrical connector as described in claim 1, wherein the first sidewall of the contact abuts against the inner wall of the passageway and the second sidewall is clear off the inner wall of the passageway.

3. The electrical connector as described in claim 2, wherein the at least one projection comprises a first projection and a second projection, which are disposed on an upper position and a lower position of the retention portion and extend beyond the second sidewall.

4. The electrical connector as described in claim 3, wherein the first projection and the second projection define commonly an outer surface parallel to the second sidewall.

5. The electrical connector as described in claim 4, wherein the first sidewall and the second sidewall are both clear off the inner wall.

6. The electrical connector as described in claim 1, wherein the contact comprises a first recess between the solder portion and the retention portion, and a second recess between the retention portion and the elastic portion.

7. The electrical connector as described in claim 6, further comprising an actuator pivotally mounted on the housing, the actuator defining a base portion and a pair of securing posts in two longitudinal ends thereof.

8. The electrical connector as described in claim 7, further comprising a cover mounted on the housing.

9. The electrical connector as described in claim 8, wherein the cover defines a first hook and a second hook.

10. An electrical connector for electrically connecting a flexible printed circuit to a printed circuit board, comprising:
a housing defining a plurality of receiving passageways therethrough, each passageway defining a width thereof; and
a plurality of contacts received in the passageways of the housing, each contact formed via a stamping process and defining a thickness and essentially extending in a planar manner; wherein
the contact includes a retention portion defining two opposite edges with bards coplanar formed on at least one of said edges and coplanar with said retention portion, and a pair of projections laterally extend respectively from said two opposite edges and angled with the retention portion to intimately engage an inner wall of the corresponding passageway.
